(19) United States
(12) Patent Application Publication
(10) Pub. No.: US 2026/0321166 A1
(43) Pub. Date: Oct. 15, 2026

(54) MODULAR COMMEMORATIVE SYSTEM WITH CUSTOMIZABLE INSERTS

(71) Applicant: MATTHEWS INTERNATIONAL CORPORATION, Pittsburgh, PA (US)

(72) Inventors: Chris Kroll, Pittsburgh, PA (US); Parker Jamison Lucas, Pittsburgh, PA (US)

(21) Appl. No.: 19/646,912

(22) Filed: Apr. 14, 2026

Related U.S. Application Data
(60) Provisional application No. 63/788,971, filed on Apr. 15, 2025.

(51) Int. Cl. G09F 7/18; B23K 26/362; B33Y 80/00

(52) U.S. Cl. CPC G09F 7/18; B23K 26/362; B33Y 80/00; G09F 2007/1843; G09F 2007/1873

(57) ABSTRACT

A modular commemorative system is disclosed. The system may include a standardized backing plate comprising one or more first recesses and a second recess; one or more first elements each comprising a customized cameo; one or more second elements each comprising customized text; and a mounting mechanism for securing the standardized backing plate to a structure. Each of the one or more first elements may be affixable to the standardized backing plate in the one or more first recesses. Each of the one or more first elements may be flush with or below a surface of the standardized backing plate. Each of the one or more second elements may be at least one of affixable or integral to the standardized backing plate in the second recess.

### CROSS-REFERENCE TO RELATED APPLICATIONS

This application claims priority to U.S. Provisional Application No. 63/788,971, filed Apr. 15, 2025, which is incorporated herein by reference in its entirety.

### TECHNICAL FIELD

The present disclosure relates generally to commemorative systems, and more particularly to modular commemorative systems with customized components.

### BACKGROUND

Commemorative products, including memorial products, such as plaques, markers, and plates serve an important role in honoring and remembering individuals, organizations, and events. These products are commonly used in cemeteries, mausoleums, columbaria, memorial gardens, corporate lobbies, educational institutions, community centers, and other settings to provide a lasting tribute to the deceased, or to recognize achievements, contributions, and milestones of individuals or organizations, or to commemorate an event. Traditionally, commemorative products have been manufactured as single, integrated pieces with limited customization options.

The production of personalized commemorative products often involves labor-intensive processes to incorporate custom text, images, and design elements for each unique piece. This can result in longer production times and higher costs, especially for products made from materials like bronze that require specialized manufacturing techniques. Additionally, errors or changes in personalization may necessitate remaking the entire product, leading to further delays and expenses.

### SUMMARY

In some embodiments, a modular commemorative system includes a standardized backing plate including one or more first recesses and a second recess; one or more first elements each including a customized cameo; one or more second elements each including customized text; and a mounting mechanism for securing the standardized backing plate to a structure, wherein each of the one or more first elements is affixable to the standardized backing plate in the one or more first recesses, wherein each of the one or more first elements is at least one of flush with or below a surface of the standardized backing plate, and wherein each of the one or more second elements is at least one of affixable or integral to the standardized backing plate in the second recess.

In some embodiments, standardized backing plate is made of bronze or granite.

In some embodiments, each of the one or more first elements is produced using at least one of a traditional printing technique or an additive manufacturing technique.

In some embodiments, a modular commemorative system, wherein each of the one or more second elements is produced using an additive manufacturing technique.

In some embodiments, the modular commemorative system further includes at least one raised divider separating each of the one or more first elements.

In some embodiments, the standardized backing plate has a beveled edge.

In some embodiments, at least a portion of the second recess is unpopulated.

In some embodiments, a method of manufacturing a modular commemorative plate includes producing a standardized backing plate, including one or more first recesses and a second recess, using a mold including foundry sand, wherein the standardized backing plate is unpopulated of any customization; providing a mounting mechanism for securing the standardized backing plate to a memorial structure; generating one or more first elements, wherein each first element includes a customized cameo; generating one or more second elements including customized text using an additive manufacturing technique; affixing each of the one or more first elements to the standardized backing plate in each of the one or more first recesses of the standardized backing plate; and affixing the one or more second elements to the standardized backing plate in the second recess.

In some embodiments, the standardized backing plate is made of bronze.

In some embodiments, producing the standardized backing plate further includes forming at least one raised divider on the standardized backing plate to separate each of the one or more first elements.

In some embodiments, the standardized backing plate has a beveled edge.

In some embodiments, affixing the one or more first elements includes positioning the one or more first elements to be at least one of flush with or below a surface of the standardized backing plate, and wherein affixing the one or more second elements includes positioning the one or more second elements to be at least one of flush with or below a surface of the standardized backing plate.

In some embodiments, generating the one or more first elements includes generating the one or more first elements using a 3D printing technique.

In some embodiments, generating the one or more second elements includes generating the one or more second elements using a laser etching technique.

In some embodiments, a modular commemorative plate includes a standardized backing plate including one or more first recesses and a second recess; a plurality of cameo inserts affixed to the standardized backing plate; one or more text elements affixed to the standardized backing plate; and a plurality of fasteners for securing the standardized backing plate to a memorial structure; wherein each of the plurality of cameo inserts is affixed to the standardized backing plate in one of the one or more first recesses, wherein each of the plurality of cameo inserts is below a surface of the standardized backing plate, and wherein the one or more text elements are affixed to the standardized backing plate in the second recess.

In some embodiments, the standardized backing plate is made of bronze.

In some embodiments, the plurality of cameo inserts are produced using at least one of a traditional printing technique or an additive manufacturing technique.

In some embodiments, the modular commemorative plate further includes at least one raised divider separating each of the plurality of cameo inserts.

In some embodiments, the standardized backing plate has a beveled edge.

In some embodiments, at least a portion of the second recess is unpopulated.

### BRIEF DESCRIPTION OF THE DRAWINGS

FIG. 1A depicts an illustrative modular niche plate with cameo inserts and a text element in accordance with an embodiment.

FIGS. 1B-1D depict various illustrative cross-sectional views of a modular plate in accordance with an embodiment.

FIG. 2 depicts an illustrative companion modular niche plate with customized elements in accordance with an embodiment.

FIG. 3 depicts an illustrative modular memorial plate with customized elements in accordance with an embodiment.

FIG. 4 depicts an illustrative companion memorial plate with customized elements in accordance with an embodiment.

FIG. 5 depicts an illustrative modular crypt plate with customized elements in accordance with an embodiment.

FIG. 6 depicts an illustrative modular memorial plate in accordance with an embodiment.

FIG. 7 depicts an illustrative modular memorial plate in accordance with an embodiment.

FIG. 8 depicts an illustrative companion modular memorial plate in accordance with an embodiment.

FIG. 9 depicts an illustrative modular commemorative plate with cameo inserts and a text element in accordance with an embodiment.

FIG. 10 depicts a flow diagram for an illustrative method of manufacturing a modular commemorative plate in accordance with an embodiment.

### DETAILED DESCRIPTION

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, compounds, or compositions, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example,“ a system having at least one of A, B, and C” would include but not be limited to systems that have A alone, B alone, C alone, A and B together, A and C together, Band C together, and/or A, B, and C together, etc.). In those instances where a convention analogous to “at least one of A, B, or C, etc.” is used, in general such a construction is intended in the sense one having skill in the art would understand the convention (for example,“ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 cells refers to groups having 1, 2, 3, 4, or 5 items, and so forth.

This disclosure is not limited to the particular systems, devices and methods described, as these may vary. The terminology used in the description is for the purpose of describing the particular versions or embodiments only and is not intended to limit the scope.

There is a growing desire among consumers for commemorative products that offer greater flexibility in design and the ability to update or modify elements over time. However, balancing customization with efficient production and installation remains challenging. Modular approaches that allow for interchangeable components could potentially address some of these issues but must be carefully designed to maintain the dignity and permanence expected of commemorative products.

As commemorative and memorial practices evolve, there is an increasing need for innovative product designs and manufacturing methods that can accommodate personalization while also considering factors such as durability, aesthetics, and ease of installation. Improved systems for creating customized commemorative products could benefit both manufacturers and end consumers in this important and meaningful industry.

The described technology generally relates to systems and methods for generating metal or stone products, for example, through a metal casting process for metals, or machining, cutting, or carving processes for stone, or other manufacturing process. In some embodiments, the products or the casting molds used to generate the products may be created using one or more hybrid, additive, or subtractive manufacturing techniques. The methods and systems described herein may be used with various materials, including, without limitation, ferrous metals, non-ferrous metals, bronze, precious metals, aluminum, stone, granite, marble, and/or combinations thereof. A mold created according to some embodiments may be used in various casting processes, including, without limitation, sand casting, shell molding, permanent mold casting, investment casting, and die casting.

The described systems may be modular. The modularity of the systems may allow for standardized portions to be uniformly mass produced while customized portions are produced on demand. The standardized and customized portions may be produced using different production methods.

In some embodiments, custom molds may be generated by a method comprising obtaining a product design through a digital input, manipulating the digital input to prepare a mold information, and making a mold from the mold information using an additive manufacturing process. In some embodiments, a method of making a cast product may comprise obtaining a product design through a digital input, manipulating the digital input to prepare the mold information, making a mold from the mold information using an additive manufacturing process, cleaning the mold, positioning the mold in a build area, forming a cast part or a cast product from the mold using a cast material; and, optionally, finishing the cast product per customer specifications. In some embodiments, one or more cast parts are needed for the cast product. In some embodiments, a plurality of molds may be produced together in the additive manufacturing process. In some embodiments, the digital input is manipulated/modified to optimize a mold design for the additive manufacturing process. In some embodiments, the digital input may be manipulated/modified to make a mold design by optimizing part size, dimensional depth, dimensional profile, profilometry (surface roughness/finish), strength, porosity, compaction, orientation, feature complexity, or the like. This manipulation and/or modification of the digital input can optimize the final product and/or processing characteristics across the scope of manufactured products. In some embodiments, the feature complexity may include typefaces or design aspects. In some embodiments, individual mold designs may be nested to optimize material use and production speed during the additive manufacturing process.

A variety of additive manufacturing technologies will be known to a person of skill in the art. Such technologies include, for example, binder jetting, directed energy deposition, material extrusion, material jetting, powder bed fusion, sheet lamination, and vat photopolymerization. These technologies may use a variety of materials for an additive manufacturing process, including various plastics and polymers, metals and metal alloys, ceramic materials, metal clays, organic materials, and the like. Any additive manufacturing technology and substrate suitable for the production of molds of embodiments herein and compatible with the molding of metal products, or compatible with the manufacturing of molds that may be subsequently used to mold metal products, is within the scope of the present disclosure. Likewise, other methods of additive manufacturing and associated materials, whether presently available or yet to be developed, are intended to be included within the scope of the present disclosure.

The modular commemorative system comprises a standardized backing plate, customizable insert elements, and a mounting mechanism. In some cases, the modular commemorative system may include a first customizable insert element comprising a cameo and a second customizable insert element comprising customized text. The first and second customizable insert elements may be affixed to the standardized backing plate. The mounting mechanism may secure the standardized backing plate to an external structure (e.g., a memorial structure or wall).

The modular design of the commemorative system may allow for various configurations to suit different commemorative needs. In some cases, the system may be configured as a modular niche plate, a memorial plate, a dedication plate, a commemorative plate, a donor plate, a signage plate, a name plate, a crypt plate, etc. Each configuration may utilize the standardized backing plate as a foundation, with customizable insert elements arranged to create a personalized display. These customizable elements may accommodate memorials for one or a plurality of individuals (e.g., couples), families, groups, organizations, donors, honorees, named spaces, events, etc.

The use of customizable insert elements, such as cameos and text elements, may provide flexibility in commemorative design. In some cases, the cameo insert may feature a photograph or artistic representation of the deceased, while the text element may include functional and/or biographical information, epitaphs, or other personalized content. Example functional text includes a date (e.g., a date of birth or a date of death) or a recognition status (e.g., most valuable player). In other cases, the cameo insert may feature a logo, emblem, or artistic representation associated with an individual, group, organization, or honoree, while the text element may include identifying or recognition-related information, such as dedication date, award date, title, affiliation, etc.

In some aspects, a cameo memorial may include a photographic representation of an individual (e.g., a deceased individual). The photograph may be reproduced using various techniques such as printing, engraving, or etching onto materials such as metal, ceramic, stone, or polymer substrates. Example metals may include aluminum or steel. Example stones may include granite or marble. The cameo may capture a likeness of the person at a significant moment in their life, such as a wedding day, graduation, or other meaningful event. In some cases, the photograph may be digitally enhanced or artistically rendered to achieve a particular aesthetic effect or to harmonize with the overall design of the memorial.

The cameo memorial may also incorporate decorative elements surrounding the photographic image, logo, emblem, or artistic representation. These elements may include ornamental borders, floral motifs, or symbolic imagery that holds personal, cultural, or organizational significance. In some implementations, the cameo may be designed with a three-dimensional effect, creating depth and dimensionality to the portrait. The size and shape of the cameo may vary to suit different memorial configurations, potentially ranging from small, oval-shaped inserts to larger rectangular formats that allow for more detailed imagery or the inclusion of scenic backgrounds that held special meaning to the person, event, or organization being memorialized.

A photograph, as described herein, may include traditional photography, manipulations thereof, or computer-generated graphics (e.g., digital art or AI generated imagery).

In some aspects, a photograph utilized in a cameo may be protected using lamination or other encapsulation techniques. The image may be sealed between layers of clear, durable plastic film through a lamination process. This lamination may help protect the image from moisture, UV radiation, and physical damage. Alternatively, the image may be encased in a clear epoxy resin. The epoxy may be poured over the image in layers to create a thick, transparent protective coating that may enhance the image durability and resistance to environmental factors.

In some cases, the cameo insert may feature a rendition of the photograph engraved or cast in metal. Generating a rendition of the photograph may involve translating the photographic image into a relief design that can be etched, carved or otherwise reproduced onto a metal or stone surface using techniques such as laser engraving or chemical etching. For cast metal renditions, the photograph may be used as a reference to create a three-dimensional model, which may then be used to produce a mold for casting the image in bronze or another suitable metal. The metal rendition may capture the essence of the original photograph while offering greater durability and a classic aesthetic that may complement traditional memorial designs. For stone renditions, the photograph may be directly engraved or carved into the stone surface.

In some aspects, the cameo insert may be configured to accommodate standard photograph sizes, allowing for easy integration of existing photographs into the memorial design. These standard sizes may include, but are not limited to, 2×3 inches (wallet size), 4×6 inches, 5×7 inches, 8×10 inches, and 11×14 inches. The use of standard sizes may simplify the process of selecting and preparing photographs for inclusion in the memorial, as many personal photographs are already available in these dimensions. Additionally, some memorial designs may incorporate multiple cameo inserts of varying sizes, such as a larger central portrait flanked by smaller images, to create a more comprehensive visual tribute.

A modular approach to memorial design may offer several advantages. In some cases, the standardized backing plate may be produced in advance, potentially reducing overall production time for individual memorials. Alternatively, a mold or die may be generated in advance to expedite production. The mold or die may be used to generate a plurality of standardized backing plates. The ability to customize insert elements separately from the backing plate may allow for an increased number of personalization options over traditional methods without affecting the core structure of the memorial.

The mounting mechanism of the modular memorial system may be designed to accommodate various memorial structures. In some cases, this may include niches, crypts, plates, or other memorial fixtures, thereby providing versatility in installation locations.

By combining standardized components with customizable elements, the modular memorial system may offer a balance between efficiency in production and personalization in design. This approach may allow for the creation of unique and meaningful memorials while potentially streamlining the manufacturing process.

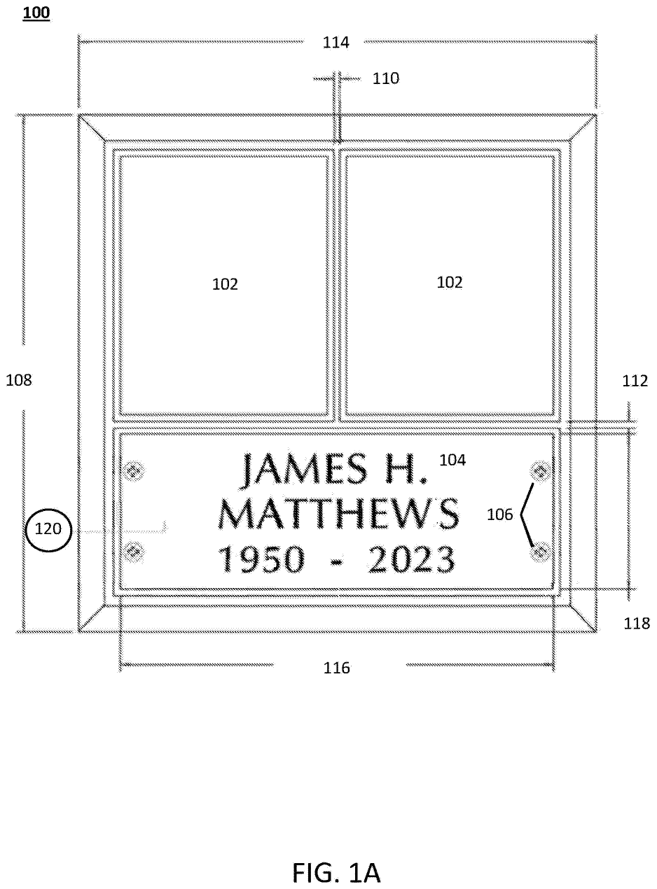

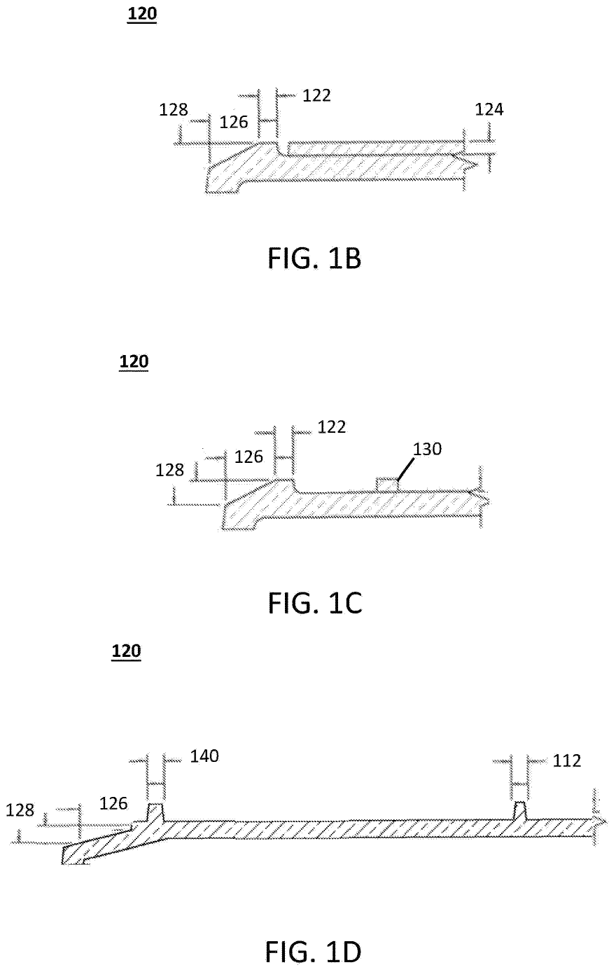

FIG. 1A illustrates a front view and side cross-sectional view of a modular niche plate 100. In some cases, the modular niche plate 100 may be configured for mounting on memorials, niches, crypts, or other memorial products. In some cases, the size of the modular niche plate 100 may be one of, but not limited to, 60×20 inches, 56×16 inches, 44×14 inches, 44×13 inches, 36×13 inches, 32×72 inches, 28×16 inches, 24×42 inches, 24×30 inches, 24×16.75 inches, 24×14 inches, 24×13 inches, 24×12 inches, 22×10 inches, and 16×24 inches. In other cases, the size of the modular nice plate 100 may be one of, but not limited to, 10×12 inches, 12×16 inches, 18×12 inches, 20×18 inches, 24×16 inches, 24×18 inches, 24×20 inches, 24×24 inches, 24×30 inches, 24×36 inches, and 36×48 inches.

In some cases, the modular niche plate 100 may include a standardized backing plate as its foundation. The backing plate may incorporate recessed and raised portions strategically designed to accommodate the customized elements described herein. These recessed areas may allow the customizable elements to sit flush with or below the surface of the standardized backing plate, while the raised portions may serve as dividers or borders (i.e., a frame) between different elements. This design approach may enable a seamless integration of personalized features within a consistent structural framework. The standardized backing plate may feature beveled, rounded, or other aesthetically pleasing edges.

The modular niche plate 100 may comprise one or more cameo inserts 102 positioned in a correspondingly sized recess in the standardized backing plate. Although the depicted cameo inserts 102 are rectangular, in some cases, a cameo insert 102 may be oval-shaped or other non-rectangular shapes. In some embodiments, the cameos may include four by five inch photographs. Additional recesses may accommodate one or more other customized elements 104 on the standardized backing plate. The customized elements 104 may be dimensioned (e.g. 116 by 118) to substantially fill the recess. Alternatively, a plurality of customized elements 104 may be dimensioned to substantially fill the recess when tiled together.

The standardized backing plate may be cast (e.g., out of bronze or aluminum). Alternatively, the standardized backing plate may be produced through any other hybrid manufacturing process as describe herein. Other materials such as zinc, stainless steel, brass, or acrylic are also considered.

In some aspects, the standardized backing plate may be produced via casting. The production process may involve using some combination of conventional sand-casting methods and additive manufacturing technologies to create different portions of the mold.

For instance, the outer beveled frame of the standardized backing plate may be cast using a traditional sand-casting method. This approach may involve creating a pattern of the frame, packing sand around it to form a mold, and then pouring molten metal into the resulting cavity. The use of conventional sand casting for this portion may be advantageous for producing the larger, simpler geometries of the frame efficiently and cost-effectively.

The more intricate portions of the standardized backing plate, such as the areas designed to divide cameo and customized elements, may be produced using a mold generated through additive manufacturing techniques. In this case, a 3D printer may be employed to create a highly detailed flask or mold insert with precise geometries for these dividing elements. This additive manufacturing approach may allow for the creation of complex internal structures and fine details that might be challenging to achieve with traditional sand casting alone.

The two portions of the mold, the traditionally produced outer frame and the additively manufactured internal dividers, may then be combined to form a complete mold for casting the standardized backing plate. This hybrid approach may leverage the strengths of both traditional and additive manufacturing methods, resulting in a final product that combines the efficiency of conventional casting with the precision and complexity enabled by additive manufacturing.

In some cases, the use of additively manufactured mold components may allow for greater flexibility in design iterations and customization of the standardized backing plate. The digital nature of the 3D printing process may facilitate rapid adjustments to the mold design, potentially enabling more efficient prototyping and production of various backing plate configurations to suit different memorial needs.

In some aspects, the cameo inserts 102 may be mounted directly to the standardized backing plate using various attachment methods. For instance, the cameo inserts 102 may be adhered to the recessed areas of the standardized backing plate using adhesives such as epoxy or silicone. These adhesives may provide a strong bond that secures the cameo inserts 102 in place while allowing them to sit flush or slightly below the surface of the standardized backing plate. Alternatively, the cameo inserts 102 may be stud welded to the standardized backing plate.

In some aspects, positioning the cameo inserts 102 slightly below the surface of the standardized backing plate may offer enhanced protection against potential damage. This recessed configuration may create a subtle barrier that shields the cameo insert from direct contact with external objects or environmental factors. For instance, if the modular niche plate 100 is installed in a ground-level memorial setting, the slightly lowered position of the cameo insert may help prevent accidental impacts from lawn maintenance equipment such as mowers or trimmers. The raised edges of the recess may act as a protective perimeter, potentially deflecting or absorbing minor collisions that might otherwise scratch, chip, or otherwise damage the delicate surface of the cameo insert. The design feature may contribute to the longevity and preservation of the memorial's personalized elements, particularly in outdoor settings where the memorial may be exposed to various maintenance activities (e.g., grounds maintenance) or environmental conditions.

Alternatively, the cameo inserts 102 may be mounted to an intermediate material before being affixed to the standardized backing plate. This intermediate material may serve as a substrate or backing for the cameo inserts 102, potentially providing additional protection or aesthetic qualities. While leatherette may be used as an intermediate material, other options may include felt, velvet, suede, cork, or synthetic materials designed to mimic various textures. In some cases, thin metal sheets or composite materials may also be employed as intermediate layers.

The attachment of cameo inserts 102 to the standardized backing plate may be designed to be either permanent or removable. Permanent attachment may involve the use of strong adhesives or mechanical fasteners that are not intended to be disassembled. On the other hand, removable attachment methods may allow for the replacement of cameo inserts 102, which may be desirable in cases where a different cameo is preferred or if the original insert becomes damaged over time.

For removable attachments, various fastening systems may be employed. These may include small screws or bolts that secure the cameo insert 102 to the standardized backing plate, allowing for easy removal when needed. In some implementations, a system of clips, brackets, and/or hook and loop fasteners may be integrated into the recessed areas of the standardized backing plate, enabling the cameo inserts 102 to be snapped in or out as required. Alternatively, adhesives which are removable or dissolvable (e.g., with solvents) may be employed.

In cases where adhesives are used for a potentially removable attachment, specialized adhesives that maintain a strong hold but can be released with the application of heat or a specific solvent may be utilized. This approach may allow for the removal and replacement of cameo inserts 102 without causing damage to the modular niche plate 100 or the insert itself.

The choice between permanent and removable attachment methods may depend on factors such as the specific design requirements, anticipated longevity of the memorial, and potential future needs for customization or maintenance. In some aspects, the modular memorial system may offer options for both permanent and removable cameo inserts 102, providing flexibility to meet diverse customer preferences and memorial applications.

In some aspects, the cameo insert may incorporate a communication element to enhance the memorial experience. The communication element may take various forms, such as a nearfield communication (NFC) device or a scannable code (e.g., a QR code). The integration of such elements may allow visitors to interact with the memorial in novel ways, potentially accessing additional information or media related to the deceased.

For instance, an NFC chip embedded within or behind the cameo insert may enable visitors with compatible smartphones or devices to retrieve digital content by simply bringing their device near the memorial. Similarly, a QR code discreetly incorporated into the design of the cameo or placed adjacent to it may be scanned using a smartphone camera.

These communication elements may provide access to external media or resources, such as a dedicated website. Such a website may host a variety of content, including photo galleries, video tributes, biographical or personal information, historical information about an event, organization, or place, or even an interactive guestbook where visitors can leave messages, share experiences or memories, or contribute related content. In some cases, the website may feature a timeline of a deceased's life, significant events, accomplishments, or other noteworthy developments associated with an individual, group, occasion, or other subject matter.

The inclusion of these interactive elements may allow for a more dynamic and evolving memorial experience. For example, families may have the option to update the linked content over time, adding new memories or information as desired. This approach may combine the permanence of a physical memorial with the flexibility and richness of digital content, potentially offering a more comprehensive and personalized tribute to the deceased.

In some cases, the width 114 and length 108 of the modular niche plate 100 may each be approximately 10 inches (i.e., forming a square). However, the dimensions may vary depending on the specific application and design requirements. In other embodiments, the width 114 and length 108 may range from about 8 inches to about 24 inches. In some aspects, the width 114 may be different from the length 108, thereby generating rectangular-shaped plates.

In some cases, the two cameo inserts 102 may be separated by a raised divider 110. In some embodiments, another raised divider 112 may separate the cameo inserts 102 from the customized element 104. In some embodiments, the raised dividers may be ⅛ inches in width.

The cameo insert 102 and the customized element 104 may be secured to the plate using fasteners 106. In some cases, various types of fasteners 106 may be used to secure components of the modular memorial system. These fasteners 106 may include screws, bolts, rivets, or specialized mounting hardware designed for memorial applications. The fasteners 106 may be made from a corrosion-resistant material, such as bronze to withstand environmental exposure. In some aspects, the fasteners 106 may be designed to be tamper-resistant or concealed to maintain the aesthetic integrity of the memorial.

Alternatively, adhesives may be employed to affix components of the modular memorial system. These adhesives may include epoxy resins, silicone-based adhesives, or specialized bonding agents formulated for use with materials commonly found in memorial products, such as bronze, stone, or composite materials. In some cases, the adhesives may be chosen for their durability, weather resistance, and ability to withstand temperature fluctuations. Some adhesives may also offer flexibility to accommodate slight movements or thermal expansion of materials. UV-resistant adhesives may be used in outdoor applications to prevent degradation from sunlight exposure. In certain aspects, the adhesives may be designed to allow for future removal or replacement of modular components if needed, while still providing a secure bond during normal use.

FIG. 1B depicts a cross-sectional profile 120 of the modular niche plate 100 in accordance with an embodiment. This view illustrates a border of the modular niche plate 100 in relation to the customized element 104. In some embodiments, the border may include a raised portion 122. The raised portion may be 3/16 inches in width. The border may include a beveled edge 126. The depth 128 of the beveled edge 126 may be ¼ inch.

FIG. 1C depicts an alternative cross-section profile 120 of the modular niche plate 100 in accordance with an embodiment. As shown in FIG. 1C, a customization (e.g., text) 130 may be integrally formed into the standardized backing plate. For example, a standard mold may be modified to cast a bronze backing plate with customized text included.

FIG. 1D depicts an alternative cross-section profile 120 of the modular niche plate 100. As illustrated, the border of the standardized backing plate may include a drop-down beveled edge. In some embodiments, the border may include a raised portion 140. The raised portion may be 3/16 inches in width.

In alternative aspects, the edge of the modular niche plate 100 may take various forms to enhance aesthetic appeal or functional characteristics. The edge may feature a rounded profile, creating a smooth transition from the face to the sides of the plate. Alternatively, the edge may incorporate a stepped design, with multiple levels transitioning from the face to the sides, potentially adding visual interest and depth to the plate's appearance. In some implementations, the edge may have a chamfered profile, where the comer is cut at a 45-degree angle, offering a balance between a sharp and rounded appearance. The edge may also be designed with a decorative pattern or texture, such as a series of small ridges or a repeating motif, which may complement the overall design of the memorial. In certain cases, the edge may be recessed, creating a shadow line that frames the plate and potentially enhances its visual prominence on the memorial structure. These alternative edge designs may be selected based on factors such as the overall aesthetic of the memorial, manufacturing considerations, or specific customer preferences.

Although the preceding cross-sections (e.g., the elements of FIGS. 1B-1D , alternative edge features, or combinations thereof) were described in reference to the modular niche plate 100, their features and functions may similarly be applied to any of the commemorative plates described herein.

The customized element 104 may display identifying or commemorative information, including name, dates, and other relevant details associated with a person, event, organization, location, occasion, or other subject matter being memorialized. The modular design of the modular niche plate 100 may allow for customization while maintaining a standardized overall structure. In some embodiments the customized element I 04 may have a depth 124 of ⅛ inch.

In some cases, the at least one raised divider 110, 112 may have a beveled edge. This feature may contribute to the aesthetic appeal of the modular niche plate 100 while also serving a functional purpose in separating different elements.

The cameo inserts 102 and customized element 104 may be flush with a surface of the modular niche plate 100. Alternatively, in some cases, these customizable insert elements may be slightly beneath the surface of the modular niche plate 100. This configuration may protect the inserts from wear and damage.

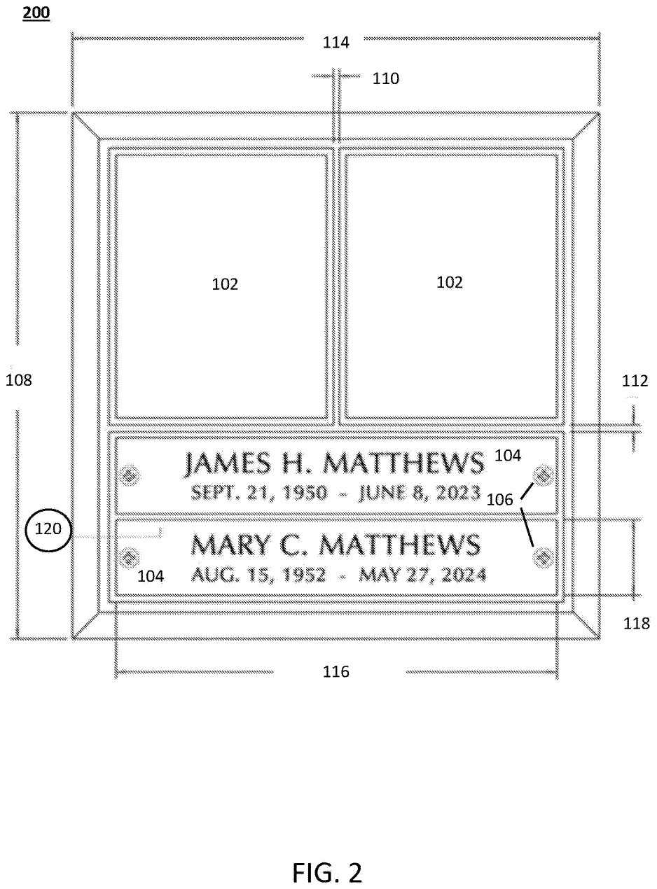

FIG. 2 depicts a companion modular niche plate 200. The companion modular niche plate 200 may be a variation of the modular niche plate 100 that is designed to accommodate memorial information for two individuals (e.g., a married couple) or additional content for a single individual.

The lower portion of the companion modular niche plate 200 may contain two customizable elements 104. The customizable elements 104 may contain memorial information such as names, dates, or other personalized content. In some embodiments, the customizable elements 104 may contain commemorative information associated with a person, event, organization, location, or occasion. In some embodiments, two customizable elements 104 of the companion modular niche plate 200 may be sized to fit on the same standardized backing plate as previously discussed in reference to FIG. 1.

Alternative embodiments having any number of additional customizable elements 104 are considered within the scope of this disclosure.

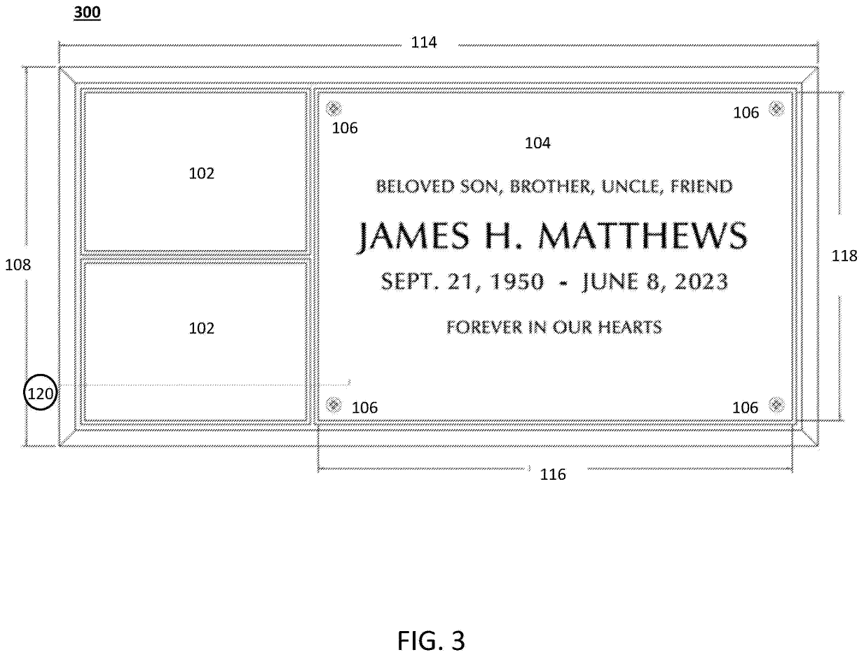

FIG. 3 depicts an individual memorial plate 300 in accordance with an embodiment. In some cases, the modular niche plate 300 may be configured for mounting on memorials, niches, crypts, or other memorial products.

In some cases, the individual memorial plate 300 may include a standardized backing plate as its foundation. The backing plate may incorporate recessed and raised portions strategically designed to accommodate the customized elements described herein. These recessed areas may allow the customizable elements to sit flush with or below the surface of the standardized backing plate, while the raised portions may serve as dividers or borders between different elements. This design approach may enable a seamless integration of personalized features within a consistent structural framework. The standardized backing plate may feature beveled, rounded, or other aesthetically pleasing edges.

The individual memorial plate 300 may comprise one or more cameo inserts 102 positioned in a correspondingly sized recess in the standardized backing plate. Although the depicted cameo inserts 102 are rectangular, in some cases, a cameo insert 102 may be oval-shaped or have other shapes besides rectangular. In some embodiments, the cameos may include seven by five inch photographs. Additional recesses may accommodate one or more other customized elements 104 on the standardized backing plate.

In some cases, the width 114 and length 108 of the individual memorial plate 300 may be 24 by 12 inches. However, the dimensions may vary depending on the specific application and design requirements.

In some cases, the two cameo inserts 102 may be separated by a raised divider 110. Another raised divider 112 may separate the cameo inserts 102 from the customized element 104. In some embodiments, the raised dividers may be ⅛ inches in width.

The cameo insert 102 and the customized element 104 may be secured to the plate using fasteners 106. In some cases, various types of fasteners 106 may be used to secure components of the modular memorial system. These fasteners 106 may include screws, bolts, rivets, or specialized mounting hardware designed for memorial applications. The fasteners 106 may be made from corrosion-resistant materials such as bronze withstand environmental exposure. In some aspects, the fasteners 106 may be designed to be tamper-resistant or concealed to maintain the aesthetic integrity of the memorial.

Alternatively, adhesives may be employed to affix components of the modular memorial system. These adhesives may include epoxy resins, silicone-based adhesives, or specialized bonding agents formulated for use with materials commonly found in memorial products, such as bronze, stone, or composite materials. In some cases, the adhesives may be chosen for their durability, weather resistance, and ability to withstand temperature fluctuations. Some adhesives may also offer flexibility to accommodate slight movements or thermal expansion of materials. UV-resistant adhesives may be used in outdoor applications to prevent degradation from sunlight exposure. In certain aspects, the adhesives may be designed to allow for future removal or replacement of modular components if needed, while still providing a secure bond during normal use.

The text element 104 may display memorial information including a name and dates. The modular design of the individual memorial plate 300 may allow for customization while maintaining a standardized overall structure.

In some cases, the at least one raised divider 110, 112 may have a beveled edge. This feature may contribute to the aesthetic appeal of the individual memorial plate 300 while also serving a functional purpose in separating different elements.

The cameo inserts 102 and text element 104 may be flush with a surface of the individual memorial plate 300. Alternatively, in some cases, these customizable insert elements may be slightly beneath the surface of the individual memorial plate 300. This configuration may protect the inserts from wear and damage.

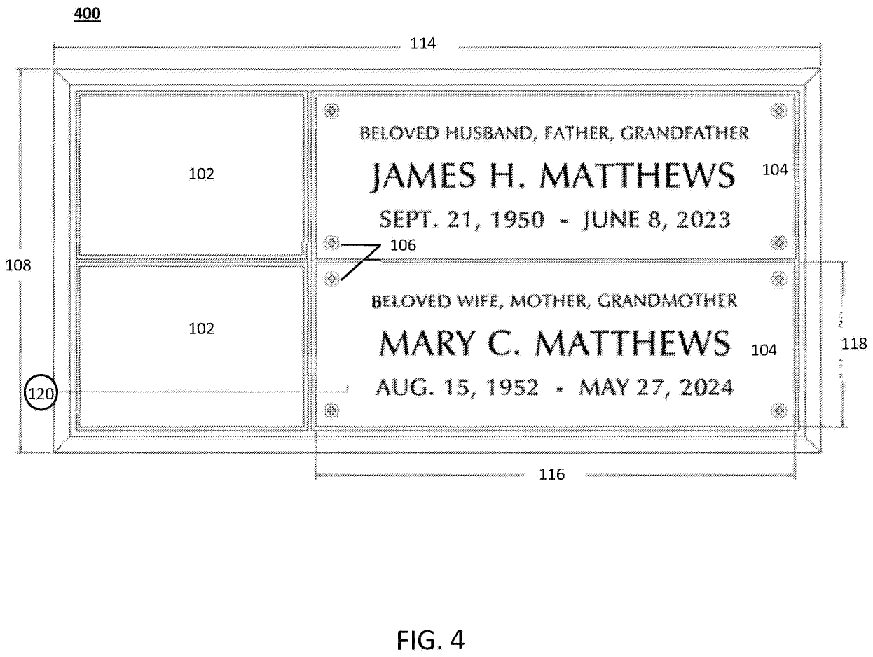

FIG. 4 depicts a companion memorial plate 400 in accordance with an embodiment. The companion memorial plate 400 may be a variation of the individual memorial plate 300 that is designed to accommodate memorial information for two individuals (e.g., a married couple), organizations, or events, or additional content for a single individual, organization, or event.

The lower portion of the companion memorial plate 400 may contain two customizable elements 104. The customizable elements 104 may contain memorial information such as names, dates, or other personalized content, or other commemorative information. In some embodiments, two customizable elements 104 of the companion memorial plate 400 may be sized to fit on the same standardized backing plate as previously discussed in reference to FIG. 3.

Alternative embodiments having any number of additional customizable elements 104 are considered within the scope of this disclosure.

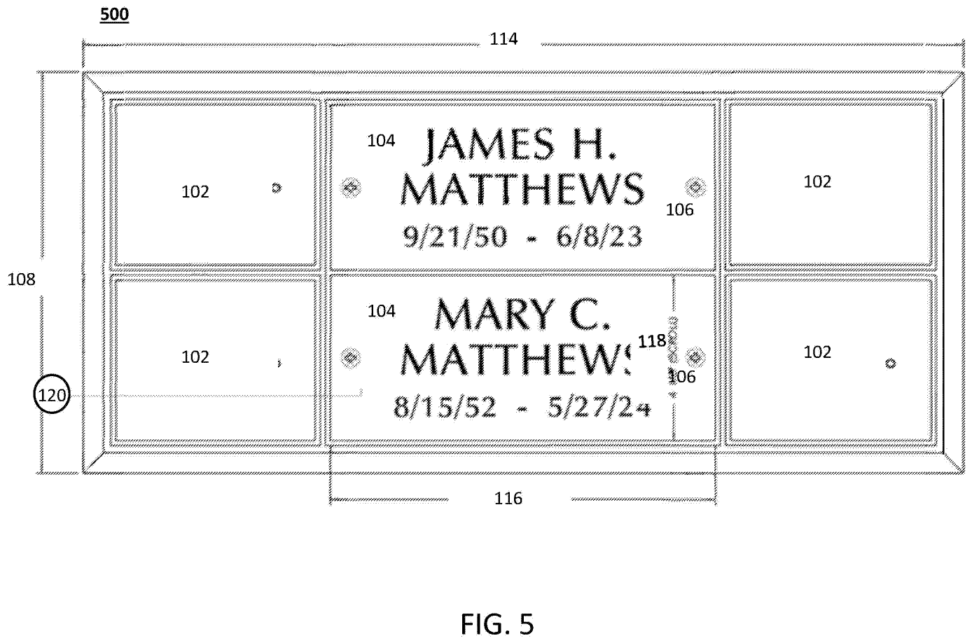

FIG. 5 depicts a crypt plate 500 in accordance with an embodiment. In some cases, the crypt plate 500 may be configured for mounting on memorials, niches, crypts, or other commemorative products.

In some cases, the crypt plate 500 may include a standardized backing plate as its foundation. The backing plate may incorporate recessed and raised portions strategically designed to accommodate the customized elements described herein. These recessed areas may allow the customizable elements to sit flush with or below the surface of the standardized backing plate, while the raised portions may serve as dividers or borders between different elements. This design approach may enable a seamless integration of personalized features within a consistent structural framework. The standardized backing plate may feature beveled, rounded, or other aesthetically pleasing edges.

The crypt plate 500 may include a plurality of cameo inserts 102 (e.g., 4) positioned in a correspondingly sized recess in the standardized backing plate. Although the depicted cameo inserts 102 are rectangular, in some cases, a cameo insert 102 may be oval-shaped or have other non-rectangular shapes. In some embodiments, the cameos may include four by five inch photographs. Additional recesses may accommodate one or more other customized elements 104 on the standardized backing plate.

In some cases, the width 114 and length 108 of the modular niche plate 100 may both be approximately 22 by 10 inches, respectively. However, the dimensions may vary depending on the specific application and design requirements.

In some cases, the cameo inserts 102 may be separated by raised dividers 110. Other raised dividers 112 may separate the cameo inserts 102 from the customized element 104. In some embodiments, the raised dividers may be ⅛ inches in width.

The cameo insert 102 and the customized element 104 may be secured to the plate using fasteners 106. In some cases, various types of fasteners 106 may be used to secure components of the modular memorial system. These fasteners 106 may include screws, bolts, rivets, or specialized mounting hardware designed for memorial applications. The fasteners 106 may be made from corrosion-resistant materials such as bronze to withstand environmental exposure. In some aspects, the fasteners 106 may be designed to be tamper-resistant or concealed to maintain the aesthetic integrity of the memorial.

Alternatively, adhesives may be employed to affix components of the modular memorial system. These adhesives may include epoxy resins, silicone-based adhesives, or specialized bonding agents formulated for use with materials commonly found in memorial products, such as bronze, stone, or composite materials. In some cases, the adhesives may be chosen for their durability, weather resistance, and ability to withstand temperature fluctuations. Some adhesives may also offer flexibility to accommodate slight movements or thermal expansion of materials. UV-resistant adhesives may be used in outdoor applications to prevent degradation from sunlight exposure. In certain aspects, the adhesives may be designed to allow for future removal or replacement of modular components if needed, while still providing a secure bond during normal use.

The customized element 104 may display memorial information including a name and dates. The modular design of the crypt plate 500 may allow for customization while maintaining a standardized overall structure.

In some cases, the at least one raised divider 110, 112 may have a beveled edge. This feature may contribute to the aesthetic appeal of the crypt plate 500 while also serving a functional purpose in separating different elements.

The cameo inserts 102 and customized element 104 may be flush with a surface of the crypt plate 500. Alternatively, in some cases, these customizable insert elements may be slightly beneath the surface of the crypt plate 500. This configuration may protect the inserts from wear and damage.

While specific arrangements of cameo inserts 102 and customized elements 104 are illustrated in the various embodiments, the modular memorial system may accommodate a wide range of alternative configurations. The number, size, shape, and positioning of cameo inserts 102 and customized elements 104 may be varied to suit different memorial requirements or aesthetic preferences. For instance, a memorial plate may incorporate a single large cameo insert 102 with multiple smaller customized elements 104, or it may feature a series of small cameo inserts 102 arranged around a central customized element 104. The modular nature of the system may allow for these components to be mixed and matched in numerous ways, providing flexibility to create unique and personalized memorial designs while still maintaining the overall structural integrity and standardized production benefits of the system.

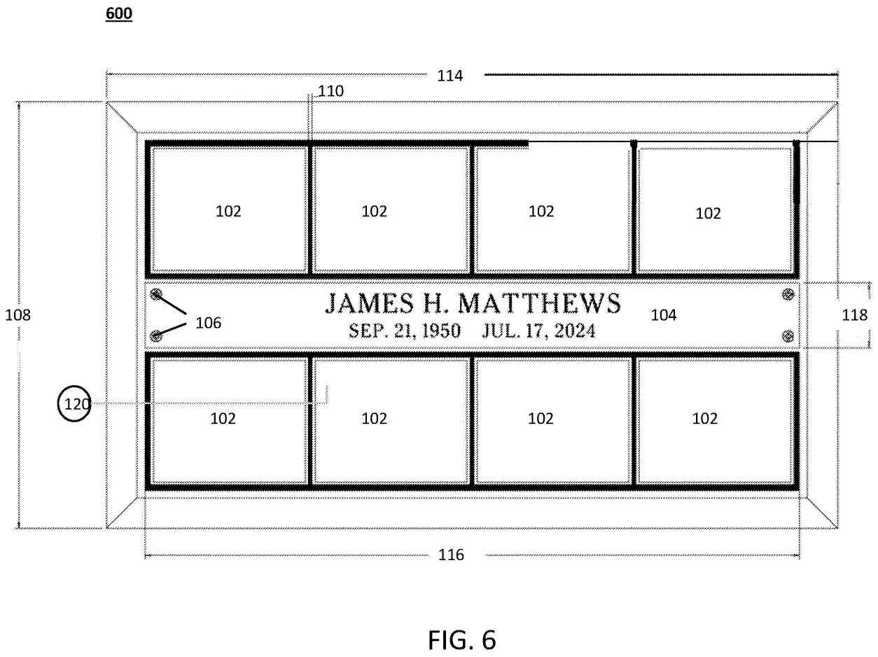

FIG. 6 illustrates an example modular memorial plate 600 in accordance with an embodiment. In some cases, dimensions of the modular niche plate 600 may be approximately 24 by 14 inches. However, the dimensions may vary depending on the specific application and design requirements. The cameo inserts 102 may be 4×5 inches.

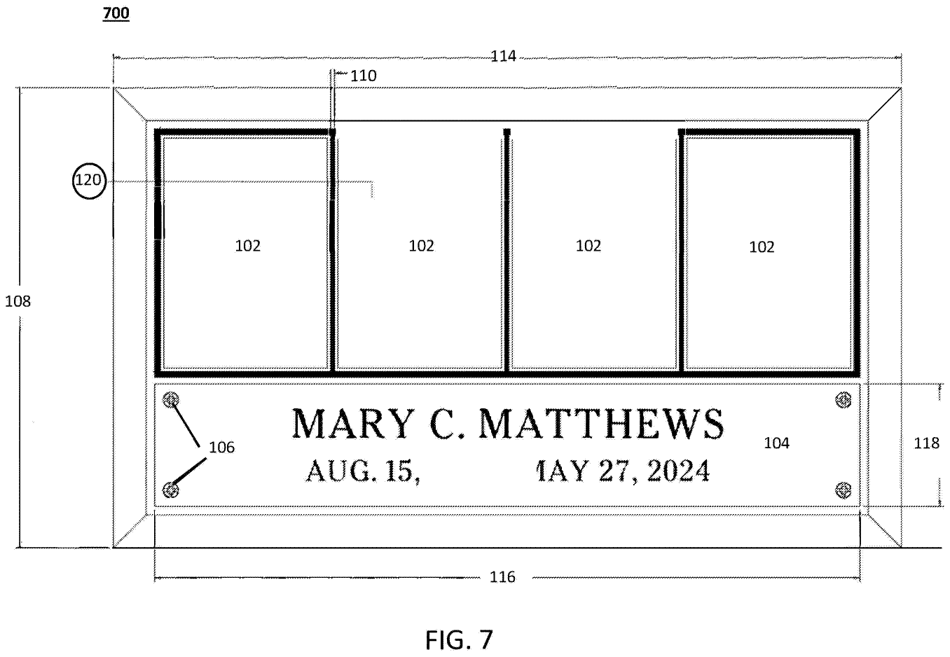

FIG. 7 illustrates an example modular memorial plate 700 in accordance with an embodiment. In some cases, dimensions of the modular niche plate 700 may be approximately 24 by 14 inches. However, the dimensions may vary depending on the specific application and design requirements. The cameo inserts 102 may be 5×7 inches.

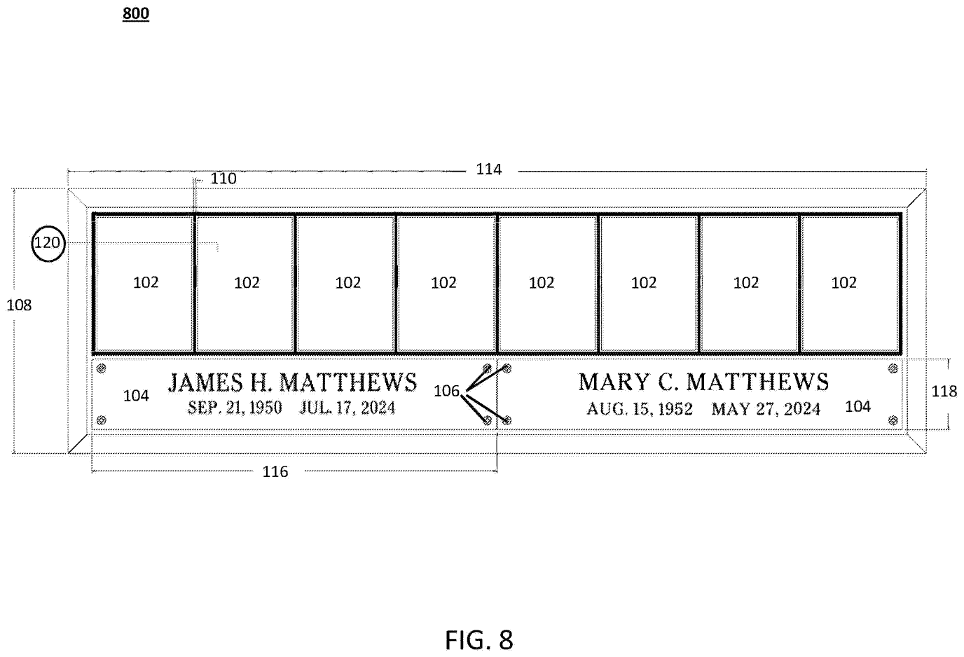

FIG. 8 illustrates an example companion modular memorial plate 800 in accordance with an embodiment. In some cases, dimensions of the companion modular niche plate 800 may be approximately 44 by 14 inches. However, the dimensions may vary depending on the specific application and design requirements. The cameo inserts 102 may be 5×7 inches.

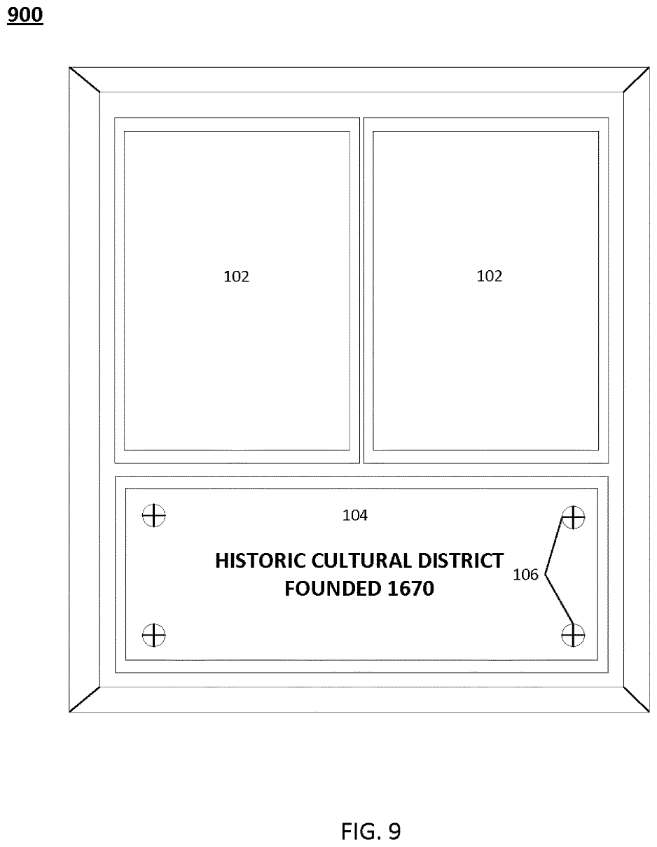

FIG. 9 illustrates an example commemorative plate 900 in accordance with an embodiment. In some cases, the modular commemorative plate 900 may include a standardized backing plate as it foundation. In some instances, the standardized backing plate may be made of stone such as granite or marble where one or more recessed and raised portions may be machined, cut, carved, or otherwise directly formed into the granite. In some instances, the standardized backing plate may be produced through manufacturing processes such as CNC machining, cutting, water jet cutting, or carving. These recessed areas may allow the customizable elements to sit flush with or below the surface of the standardized backing plate, while the raised portions may serve as dividers or borders (i.e., a frame) between different elements. The standardized backing plate may feature beveled, rounded, or other aesthetically pleasing edges.

The modular commemorative plate 900 may comprise one or more cameo inserts 102 positioned in a correspondingly sized recess in the standardized backing plate. Although the depicted cameo inserts 102 are rectangular, in some cases, a cameo insert 102 may be oval-shaped or other non-rectangular shapes. In some embodiments, the cameos may include four by five inch photographs. Additional recesses may accommodate one or more other customized elements 104 on the standardized backing plate. The customized elements 104 may be dimensioned to substantially fill the recess. Alternatively, a plurality of customized elements 104 may be dimensioned to substantially fill the recess when tiled together. In this example, the customized element 104 is dedicated to a “Historic Cultural District.”

In this example, the customized element 104 is secured to the plate 900 using fasteners 106, which may include screws, bolts, rivets, or specialized mounting hardware. In some cases, the cameo inserts and other customized elements may be affixed directly to the granite, for example by gluing or adhering the elements onto the recessed surfaces of the granite plate using an adhesive such as epoxy.

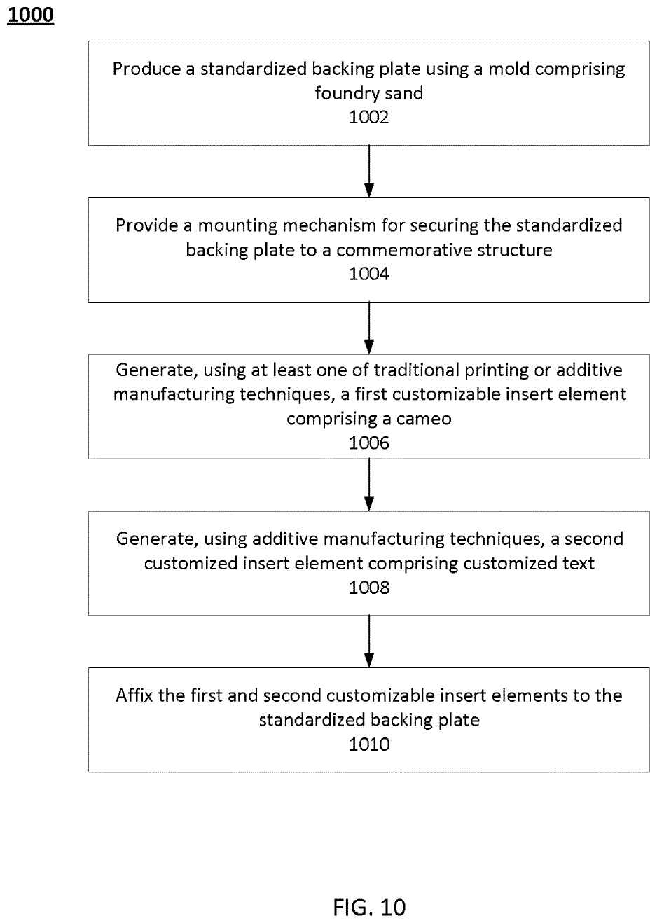

FIG. 10 depicts a flowchart of an illustrative method 1000 for manufacturing a modular commemorative plate. The method 1000 may include several steps for producing and assembling the components of the modular commemorative plate.

In some cases, the method 1000 may include producing 1002 a standardized backing plate using a mold comprising foundry sand. In some cases, the use of traditional casting techniques may offer an economical solution, particularly when manufacturing in larger quantities across multiple orders. The standardized nature of this component may allow for efficient production using established foundry methods because portions of the mold, or the backing plate itself, may be produced prior to receiving an order.

Following the production of the standardized backing plate, the method 1000 may include providing 1004 a mounting mechanism for securing the standardized backing plate to a commemorative structure. This mounting mechanism may enable the modular commemorative plate to be affixed to various types of commemorative fixtures or surfaces (e.g., stone).

In some cases, the standardized backing plate may be made of bronze and configured for insertion into a commemorative fixture made of a stone material such as granite or marble. In such embodiments, a recess may be formed into the stone commemorative fixture by machining, cutting, water jet cutting, or carving a portion of the granite or marble to define a recessed area that is dimensioned to receive the standardized backing plate. The standardized backing plate may be inserted and seated into the recessed area of the fixture such that the standardized backing plate sits substantially flush with an outer surface of the fixture or slightly below the outer surface of the fixture.

The standardized backing plate may be mounted to the commemorative structure, such as a stone, e.g., granite or marble, monument, using various techniques. In some cases, threaded studs or bolts may be cast into or welded onto the back of the plate, allowing it to be secured to the stone surface using epoxy or mechanical anchors. Alternatively, the plate may incorporate keyhole slots or hanging brackets that can engage with corresponding mounting hardware affixed to the stone. In some implementations, a strong adhesive specifically formulated for bonding metal to stone may be used to attach the backing plate directly to the memorial surface. For added security, a combination of adhesive and mechanical fasteners may be employed. In certain cases, the backing plate may feature a channel or groove system that allows it to slide onto and interlock with complementary mounting brackets pre-installed on the stone memorial. These mounting options may provide flexibility to accommodate different types of stone memorials and installation requirements while ensuring a secure and durable attachment of the modular memorial plate. An example system for affixing a plaque to a solid surface can be found in U.S. Pat. No. 11,371,543, which is hereby incorporated by reference in its entirety.

The method 1000 may include generating 1006 a first customizable insert element comprising a cameo insert 102 using at least one of traditional printing, casting, or hybrid (e.g., additive and/or subtractive) manufacturing techniques as described herein.

The method 1000 may include generating 1008 a second customized insert element including a customized text element 104 using at least one of traditional printing, casting, or hybrid (e.g., additive and/or subtractive) manufacturing techniques as described herein.

The method 1000 may include affixing 1010 the first and second customizable insert elements to the standardized backing plate. In some cases, affixing the first and second customizable insert elements may include positioning the elements to be flush with or slightly beneath a surface of the standardized backing plate and attaching them with a fastener and/or adhesive.

The manufacturing method 1000 may allow for efficient production of standardized components while still enabling customization through the use of additive manufacturing techniques for the insert elements. This approach may provide flexibility in design while maintaining consistency in the overall structure of the modular memorial plate.

The modular memorial system may incorporate various materials in its construction with each component potentially utilizing different materials to achieve specific properties and aesthetics. In some cases, the standardized backing plate may be made of bronze. Bronze may be chosen for its durability, resistance to corrosion, and traditional appearance in memorial applications. In some cases, the standardized backing plate may be made of stone such as granite or marble. Stone may be chosen for its durability, natural appearance, and suitability for engraving, etching or carving for certain applications.

In some cases, the customized elements may be made of bronze, other metals, leather, leatherette, or a combination thereof. The choice of material for the customized element may depend on factors such as desired appearance, durability, environmental considerations, and manufacturing considerations. When leather or leatherette is used, the customized element may be wrapped around a harder backing such as metal or plastic to provide structural support.

The manufacturing techniques employed in producing the modular memorial system may vary depending on the component and desired outcome. In some cases, traditional casting methods may be used for producing standardized pieces, such as the backing plate. This approach may allow for efficient production of consistent, high-quality components.

For customizable elements, one or more additive manufacturing techniques may be employed. In some cases, the first customizable insert element, such as a cameo insert, may be produced using one or more additive manufacturing techniques. Similarly, the second customizable insert element, which may include customized text, may also be produced using one or more additive manufacturing techniques.

In further embodiments, the cameo inserts and customized elements may be produced through one or more hybrid manufacturing techniques. These techniques may include 3D printing, casting in a 3D printed mold, laser etching, CNC machining, or other computer-controlled manufacturing systems. The use of hybrid manufacturing techniques may allow for greater flexibility in design and potentially faster production times for customized elements.

The text on the text element may be created in different ways. In some cases, the text may be separate elements adhered to the customized element. Alternatively, the text may be integral to the text element such as text produced through engraving or embossing.

To optimize production efficiency, the cameo insert and customized element may be produced in batches for multiple final plates. In some cases, elements may be nested to maximize utilization of the additive or subtractive manufacturing device. This approach may allow for more efficient use of materials and manufacturing time, potentially reducing overall production costs. Various nesting strategies applicable to additive manufacturing are described in U.S. Pat. No. 11,745,253, which is hereby incorporated by reference in its entirety.

The modular commemorative systems described herein may be utilized in various commemorative and memorial applications. In some cases, these systems may be employed in cemeteries, mausoleums, columbaria, or memorial gardens to honor and remember deceased individuals. The modular nature of the systems may allow for flexible and personalized memorialization or commemorative options.

In some aspects, a modular commemorative system may be used for an individual memorial. These may include single niche plates, individual memorial plaques, or standalone markers. The customizable elements, such as cameo inserts and text elements, may be arranged to showcase the life and personality of the memorialized individual.

In some aspects, a modular commemorative system may be used for a companion memorial, such as for couples or family members who wish to be remembered together. In some cases, a dual memorial plate may be installed with customized elements for both (or all) individuals. The modular design may allow for the addition or modification of elements over time as needed.

In some aspects, a modular commemorative system may be used to commemorate events, occasions, places, or organizations. In some cases, a plate, plaque, marker, or display may be installed with customized elements corresponding to the relevant subject matter such as donor recognition, dedication, anniversary celebration, historical information, celebratory content, images, logo, symbols, etc.

In some implementations, portions of a modular commemorative system, such as a companion memorial plate, may intentionally not be populated to allow for future customization. This approach may be particularly useful in pre-need memorial planning or in cases where a living spouse wishes to reserve space for their future memorialization. For example, the companion memorial plate may be installed with one side fully customized for a deceased individual, while the other side remains partially or fully unpopulated, ready for future customization.

In some embodiments, temporary placeholders or decorative elements may be placed in some portions of a companion memorial plate. Such elements may be replaced with memorial elements at a later time. In some cases, such elements may be designed to complement the overall aesthetics of the memorial while indicating the reserved nature of the space.

In some aspects, a modular commemorative system may also find application as a memorial for a group or an organization. In some implementations, multiple modular plates may be arranged together to form a larger memorial wall or display. This approach may be used for commemorating members of a particular organization, individuals associated with a specific event, or groups of individuals having a shared connection.

In some cases, the modular commemorative system may be employed as a living memorial, where the memorial evolves over time. For instance, a family plot memorial may start with a central plate and gradually expand with additional modular elements as additional family members are memorialized. The standardized nature of the backing plates may allow for seamless integration of new elements over time.

The customizable nature of the modular commemorative system may also allow for the creation of themed memorials. In some implementations, cameo inserts and text elements may be designed to reflect a particular theme, such as military service, artistic achievements, or cultural heritage. The ability to mix and match different elements may provide flexibility in creating a cohesive and meaningful themed memorial.

In some aspects, a modular commemorative system may be used in conjunction with digital memorial technologies. For example, QR codes or NFC tags that link to online memorial pages or digital archives of the deceased individual's life and achievements may be incorporated into one or more customized elements. This integration of physical and digital memorialization may provide a more comprehensive and interactive remembrance experience.

The combination of traditional and modern manufacturing techniques in the production of the modular memorial system may offer several benefits. Traditional casting methods for standardized pieces may provide consistency and reliability, while additive and hybrid manufacturing techniques for customized elements may allow for greater personalization and potentially faster production times. This hybrid approach to manufacturing may enable the creation of unique and meaningful memorials while potentially streamlining the overall production process.

The modular memorial system may offer a wide range of customization options, allowing for personalized and meaningful memorials. In some cases, the standardized backing plate may serve as a foundation upon which various customizable elements can be arranged and affixed.

The modular memorial system may also provide advantages in terms of inventory management and logistics. In some cases, the standardized components may be stocked in advance, while customizable elements may be produced on-demand. This approach may help optimize inventory levels and reduce storage requirements for memorial providers.

Although the examples presented herein refer to memorials, a person of ordinary skill in the art will recognize the products described herein may also be utilized in other industries (e.g., recognition plaques) to commemorate any person, organization, and/or event.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the embodiments described above.

1. A modular commemorative system, comprising:
a standardized backing plate comprising one or more first recesses and a second recess;
one or more first elements each comprising a customized cameo;
one or more second elements each comprising customized text; and
a mounting mechanism for securing the standardized backing plate to a structure, wherein each of the one or more first elements is affixable to the standardized backing
plate in the one or more first recesses, wherein each of the one or more first elements is at least one of flush with or below a surface of the standardized backing plate, and wherein each of the one or more second elements is at least one of affixable or integral to the standardized backing plate in the second recess.

2. The modular commemorative system of claim 1, wherein the standardized backing plate is made of bronze or granite.

3. The modular commemorative system of claim 1, wherein each of the one or more first elements is produced using at least one of a traditional printing technique or an additive manufacturing technique.

4. The modular commemorative system of claim 1, wherein each of the one or more second elements is produced using an additive manufacturing technique.

5. The modular commemorative system of claim 1, further comprising at least one raised divider separating each of the one or more first elements.

6. The modular commemorative system of claim 1, wherein the standardized backing plate has a beveled edge.

7. The modular commemorative system of claim 1, wherein at least a portion of the second recess is unpopulated.

8. A method of manufacturing a modular commemorative plate, comprising:
producing a standardized backing plate, comprising one or more first recesses and a second recess, using a mold comprising foundry sand, wherein the standardized backing plate is unpopulated of any customization;
providing a mounting mechanism for securing the standardized backing plate to a memorial structure;
generating one or more first elements, wherein each first element comprises a customized cameo,
generating one or more second elements comprising customized text using an additive manufacturing technique;
affixing each of the one or more first elements to the standardized backing plate in each of the one or more first recesses of the standardized backing plate; and
affixing the one or more second elements to the standardized backing plate in the second recess.

9. The method of claim 8, wherein the standardized backing plate is made of bronze.

10. The method of claim 8, wherein producing the standardized backing plate further comprises forming at least one raised divider on the standardized backing plate to separate each of the one or more first elements.

11. The method of claim 8, wherein the standardized backing plate has a beveled edge.

12. The method of claim 8, wherein affixing the one or more first elements comprises positioning the one or more first elements to be at least one of flush with or below a surface of the standardized backing plate, and wherein affixing the one or more second elements comprises positioning the one or more second elements to be at least one of flush with or below a surface of the standardized backing plate.

13. The method of claim 8, wherein generating the one or more first elements comprises generating the one or more first elements using a 3D printing technique.

14. The method of claim 8, wherein generating the one or more second elements comprises generating the one or more second elements using a laser etching technique.

15. A modular commemorative plate, comprising:
a standardized backing plate comprising one or more first recesses and a second recess; a plurality of cameo inserts affixed to the standardized backing plate;
one or more text elements affixed to the standardized backing plate; and
a plurality of fasteners for securing the standardized backing plate to a memorial structure;
wherein each of the plurality of cameo inserts is affixed to the standardized backing plate in one of the one or more first recesses, wherein each of the plurality of cameo inserts is below a surface of the standardized backing plate, and wherein the one or more text elements are affixed to the standardized backing plate in the second recess.

16. The modular commemorative plate of claim 15, wherein the standardized backing plate is made of bronze or granite.

17. The modular commemorative plate of claim 15, wherein the plurality of cameo inserts are produced using at least one of a traditional printing technique or an additive manufacturing technique.

18. The modular commemorative plate of claim 15, further comprising at least one raised divider separating each of the plurality of cameo inserts.

19. The modular commemorative plate of claim 15, wherein the standardized backing plate has a beveled edge.

20. The modular commemorative plate of claim 15, wherein at least a portion of the second recess is unpopulated.
